(19) United States
(12) Patent Application Publication
(10) Pub. No.: US 2015/0162652 A1
(43) Pub. Date: Jun. 11, 2015

(54) CONTROL METHOD AND SYSTEM FOR BATTERY COOLING FAN

(71) Applicant: Hyundai Motor Company, Seoul (KR)

(72) Inventor: Hui Tae YANG, Seoul (KR)

(21) Appl. No.: 14/299,947

(22) Filed: Jun. 9, 2014

(30) Foreign Application Priority Data
Dec. 6, 2013 (KR) 10-2013-0151882

(51) Int. Cl. H01M 10/625; H01M 10/6563; H01M 10/633

(52) U.S. Cl. CPC H01M 10/5016; H01M 10/5022; H01M 10/5067; H01M 2220/20

(57) ABSTRACT

A control method and a system for a battery cooling fan include calculating an estimated driving time duration, and controlling cooling of a battery according to the calculated estimated driving time duration and a signal indicating whether a passenger is in a back seat of a vehicle from a sensor disposed at a door of the vehicle.

### CROSS REFERENCE TO RELATED APPLICATION

The present application claims the benefit of priority to Korean Patent Application Number 10-2013-0151882 filed on Dec. 6, 2013, the entire contents of which is incorporated herein for all purposes by this reference.

### TECHNICAL FIELD

The present disclosure relates to a control method and a system for a battery cooling fan, and more particularly, to a control method and a system for a battery cooling fan capable of securing battery life and output performance according to battery cooling.

### BACKGROUND

Hybrid vehicles use an engine and a driving motor as a power source and employ a high voltage battery which is repeatedly charged and discharged according to a vehicle driving situation. In an idle state, an engine is stopped and a battery is charged with electricity generated by a driving motor. When a hybrid vehicle is accelerated, power from the driving motor is used as auxiliary power, and power of the engine is transferred to a wheel through a transmission. In order to generate power by the driving motor, the battery may be discharged.

When using a cruise control function, an engine clutch coupling the engine and the driving motor is connected to allow the power from the engine and the power from the driving motor to be delivered to a driving shaft. The engine power is used as wheel source power, and the motor power is used to charge the battery through an idle generation. During deceleration, fuel supply to the engine is cut off, and the motor charges the battery through regenerative braking. The high voltage battery may have a problem of stability at high temperatures, and durability thereof may be reduced. Thus, it needs to be cooled, and various cooling methods are used to prevent a temperature of the high voltage battery from being increased.

In case of an air cooling method, the temperature of the high voltage battery is controlled by using a cooling fan. However, when the cooling fan is driven, noise is generated. Such fan noise may reduce marketability of the hybrid vehicle, so cooling is passively performed by lowering a cooling level of the cooling fan as low as possible.

Japanese Patent Laid-Open Publication No. 2007-331737 discloses a technique of controlling a cooling fan, such that an air volume thereof is increased to be greater when a crew member sits in a back seat than when a crew member does not sit in the back seat. However, the technique merely delays a temperature increase rather than lowering a temperature of a battery.

The matters described as the related art have been provided only for assisting in the understanding for the background of the present disclosure and should not be considered as corresponding to the related art known to those skilled in the art.

### SUMMARY

An aspect of the present disclosure provides a control method and a system for a battery cooling fan capable of controlling the battery cooling fan in consideration of a scheduled driving time, thus minimizing power consumption, while stably securing battery life and output performance.

According to an exemplary embodiment of the present disclosure, a control method for a battery cooling fan includes calculating an estimated driving time duration. Cooling of a battery is controlled according to the calculated estimated running time duration and a signal indicating whether a passenger is in a back seat of a vehicle from a sensor disposed at a vehicle door.

The step of calculating may include calculating a difference between a scheduled destination arrival time and a starting place driving start time input through a navigator.

The control method may further include comparing the calculated estimated driving time duration with a reference time duration.

The control method may further include when the calculated estimated driving time duration is longer than the reference time duration, receiving a signal indicating whether the passenger is in the back seat.

In the step of controlling, when the calculated estimated driving time duration is shorter than the reference time duration, a cooling level of the battery cooling fan o may be minimized.

When the signal indicating that the passenger is in the back seat is received, the cooling level of the battery cooling fan may be minimized.

The step of controlling may include raising the cooling level of the battery cooling fan for cooling the battery as the calculated estimated driving time duration is longer.

The signal indicating whether the passenger is in the back seat may be received again when the door opens and closes.

According to another exemplary embodiment of the present disclosure, a control system for a battery cooling fan includes a navigator receiving operation information. A sensor senses whether a passenger gets in a back seat. A controller calculates an estimated driving time duration on the basis of the operation information and controls an operation of the battery cooling fan for cooling a battery on the basis of the calculated estimated driving time duration and a signal indicating whether the passenger is in the back seat from the sensor, wherein the sensor is disposed at a vehicle door.

### BRIEF DESCRIPTION OF THE DRAWINGS

FIG. 1 is a block diagram of a control system for a battery cooling fan according to an exemplary embodiment of the present disclosure.

FIG. 2 is a flow chart illustrating a control method for a battery cooling fan according to an exemplary embodiment of the present disclosure.

FIG. 3 is a conceptual view of passenger ride sensing logic of a vehicle.

FIG. 4 is a view illustrating a position that may be sensed by a sensor disposed at a vehicle door.

### DETAILED DESCRIPTION

Specific structural or functional descriptions of embodiments of the preset disclosure disclosed in the present disclosure or application are illustrated for the purpose of describing embodiments of the present disclosure. Embodiments of the present disclosure may be implemented in various forms and should not be construed to be limited to the embodiments described in the present disclosure or application.

The present disclosure may be modified variably and may have various embodiments, particular examples of which will be illustrated in drawings and described in detail. However, it is to be understood that the present disclosure is not limited to a specific disclosed form, but includes all modifications, equivalents, and substitutions without departing from the scope and spirit of the present disclosure.

Terms such as ‘first’, ‘second’, etc., may be used to describe various components, but the components are not to be construed as being limited to the terms. The terms are used only to distinguish one component from another component. For example, the ‘first’ component may be named the ‘second’ component, and the ‘second’ component may also be similarly named the ‘first’ component, without departing from the scope of the present disclosure.

It is to be understood that when one element is referred to as being “connected to” or “coupled to” another element, it may be connected directly to or coupled directly to another element or be connected to or coupled to another element, having the other element intervening therebetween. On the other hand, it is to be understood that when one element is referred to as being “connected directly to” or “coupled directly to” another element, it may be connected to or coupled to another element without the other element intervening therebetween. Other expressions describing a relationship between components, that is, “between”, “directly between”, “neighboring to”, “directly neighboring to,” and the like, should be similarly interpreted.

Terms used in the present specification are used only in order to describe specific exemplary embodiments rather than limiting the present disclosure. Singular forms are intended to include plural forms unless the context clearly indicates otherwise. It will be further understood that the terms “comprises” or “have” used in this specification, specify the presence of stated features, steps, operations, components, parts, or a combination thereof, but do not preclude the presence or addition of one or more other features, numerals, steps, operations, components, parts, or a combination thereof.

Unless indicated otherwise, it is to be understood that all the terms used in the specification, including technical and scientific terms have the same meaning as those that are understood by those skilled in the art to which the present disclosure pertains. It must be understood that the terms defined by the dictionary are identical with the meanings within the context of the related art, and they should not be ideally or excessively formally defined unless the context clearly dictates otherwise.

Hereinafter, exemplary embodiments of the present disclosure will be described in detail with reference to the accompanying drawings. Throughout the accompanying drawings, the same reference numerals indicate the same members.

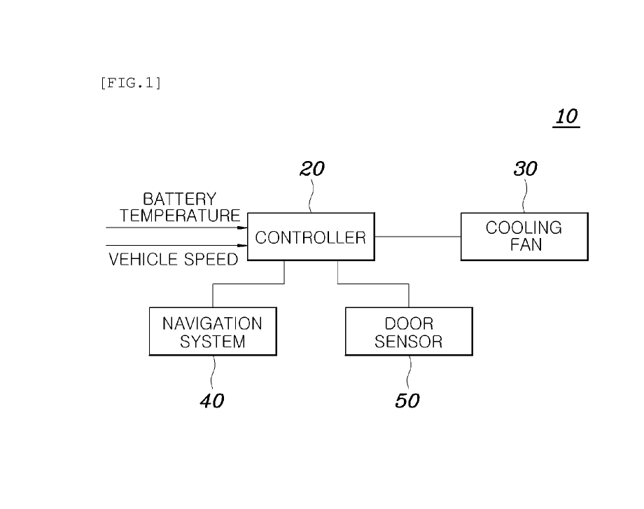

FIG. 1 is a block diagram of a control system for a battery cooling fan according to an exemplary embodiment of the present disclosure. A control system 10 for a battery cooling fan may include a controller 20, a battery cooling fan 30, a navigator (AVN) 40, and a door sensor 50.

The controller 20 may receive information regarding a battery temperature and a vehicle speed and calculates an estimated driving time duration of a vehicle on the basis of a scheduled destination arrival time and a starting place driving start time (operation information) according to starting place and destination information from the navigator 40. The controller 20 may calculate the estimated driving time duration of the vehicle by using a difference between the scheduled destination arrival time and the starting place driving start time. The controller 20 may compare a calculated estimated driving time duration with a reference time duration. When the calculated estimated driving time duration is longer than the reference time duration, the controller 20 may receive a signal indicating whether a passenger is in the back seat. When the calculated estimated driving time duration is shorter than the reference time duration, the controller 20 may minimize a cooling level of the battery cooling fan (or lower the cooling level of the battery cooling fan to have the lowest cooling level).

When the signal indicating that the passenger is in the back seat is received, the controller 20 may minimize the cooling level of the battery cooling fan. When the calculated estimated driving time duration is longer, the controller 20 may raise the cooling level of the battery cooling fan 30 that cools a battery to rotate the battery cooling fan 30. The controller 20 may receive information regarding a destination input by a driver through the navigator 40, receive a signal indicating whether the passenger is in the back seat from the sensor 50 disposed at a vehicle door, and control cooling of the battery. The battery cooling fan 30 is an element for cooling the battery. The battery may be cooled by driving the battery cooling fan 30.

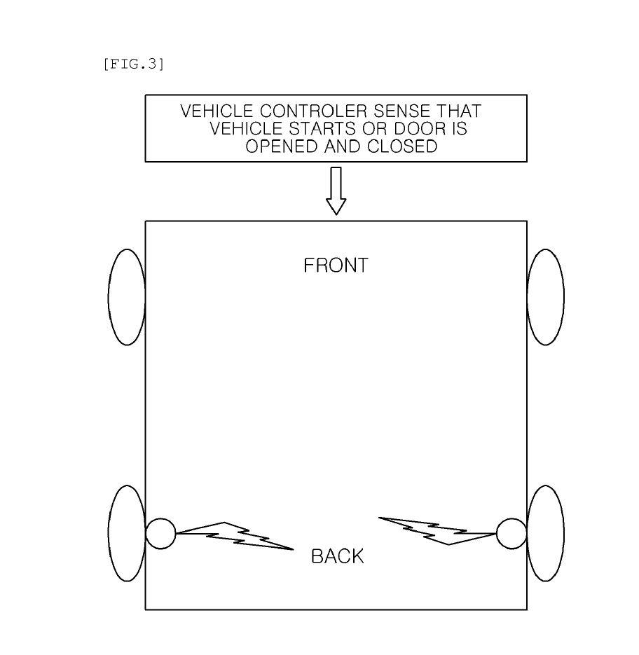

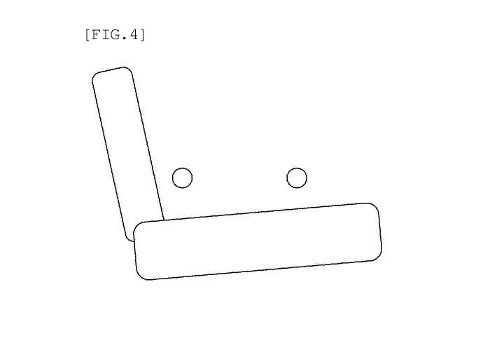

The door sensor 50, disposed at a door, may be an infrared sensor. When the vehicle starts, or when the vehicle door is opened or closed, the controller 20 may receive a signal indicating whether the passenger is in the back seat from the sensor to minimize the cooling level of the battery cooling fan 30. By using the sensor attached to the door, damage due to vibration, impact, or the like, may be reduced, and whether the passenger is stably seated in the back seat may be ascertained by a sensor configured below the seat. Also, the sensor may be operated only when needed, thus reducing the number of sensor usage times and securing stable sensor life. FIG. 3 is a conceptual view of passenger ride sensing logic of a vehicle, and FIG. 4 is a view illustrating a position that may be sensed by a sensor installed at a vehicle door. Referring to FIGS. 1, 3, and 4, it can be seen that the sensor operates only when the vehicle starts, or only when opening and closing of the door is sensed. Also, a sensor position to sense a passenger may be set to sense when a passenger gets in. Accordingly, only a required number of sensors may be installed.

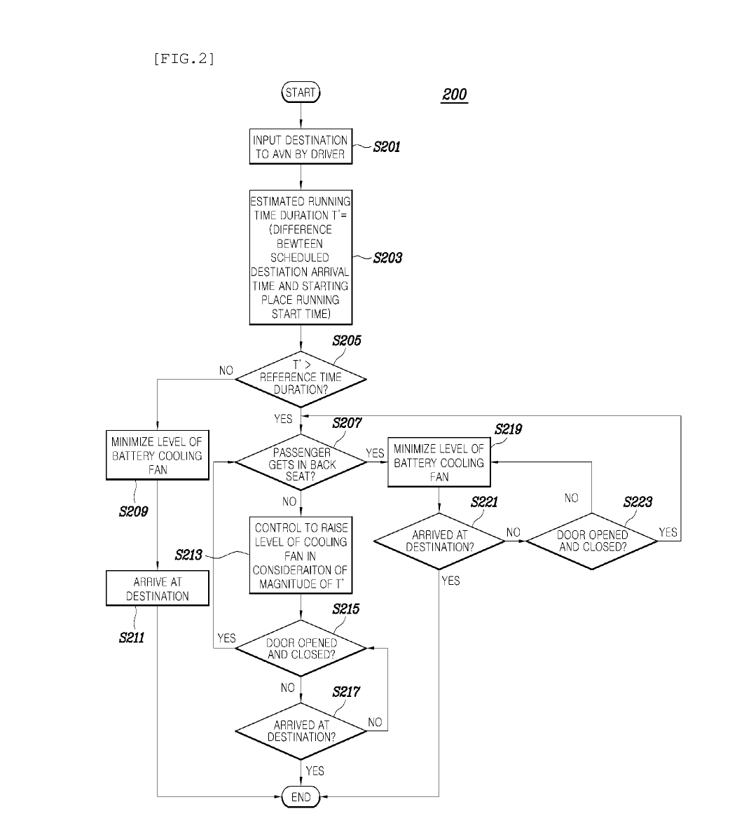

FIG. 2 is a flow chart illustrating a control method for a battery cooling fan according to an exemplary embodiment of the present disclosure. Referring to FIGS. 1 and 2, when a driver inputs a destination through the navigator 40 (S201), the vehicle controller 20 may calculate an estimated driving time duration by using a difference between a scheduled destination arrival time and a starting place driving start time (S203). When the estimated driving time duration is determined, the controller 20 may compare a calculated estimated driving time duration with a reference time duration (S205).

The controller 20 may compare the calculated estimated driving time duration with the reference time duration (S205). Such a reference time duration may be set in advance as a time duration within which driving may be terminated without increasing a temperature to a cooling level too high as to affect durability and output of the battery due to shortage of the estimated driving time. If the estimated driving time duration is longer than the reference time duration, the temperature may be increased enough to affect the durability and the output of the battery.

When the calculated estimated driving time duration is shorter than the reference time duration, the controller 20 may minimize the cooling level of the battery cooling fan 30 for cooling the battery (S209). When the calculated estimated driving time duration is shorter than the reference time duration, a temperature is not increased too high so as to affect durability and output of the battery, necessity of cooling the battery is removed, and thus, there is no need to unnecessarily consume additional power by preliminarily performing overcooling. When driving is expected to be terminated without increasing the temperature of the battery, the cooling level of the battery cooling fan 30 may be minimized to reduce power consumption.

In the case in which the calculated estimated driving time duration is longer than the reference time duration, the controller 20 may receive a sensing value indicating whether the passenger is seated in the back seat from the sensor disposed at the door (S207). When the controller 20 determines that the passenger is seated in the back seat according to the received sensing signal value, the controller 20 may minimize the cooling level of the battery cooling fan 30 for cooling the battery, so that the passenger in the back seat may not recognize noise of the battery cooling fan (S219). Since the passenger in the back seat would primarily hear noise caused as the battery cooling fan rotates, whether or not the passenger is in the back seat is detected by using the sensor disposed at the door, and the battery cooling fan is subsequently controlled.

When the vehicle arrives at the destination (S221), the controlling of the battery cooling fan according to an exemplary embodiment of the present disclosure is terminated. If the door of the vehicle is opened and closed before the vehicle arrives at the destination (S223), the sensing value indicating whether the passenger is in the back seat is received again (S207). Although the vehicle has not arrived at the destination yet, if the door of the vehicle is not opened and closed, the vehicle continues to drive to the destination.

In the case in which the calculated estimated driving time duration is longer than the reference time duration, the controller 20 may receive the sensing signal value indicating whether or not the passenger is in the back seat from the sensor disposed at the door (S207). When the controller 20 determines that the passenger is not in the back seat according to the received sensing signal value, the controller 20 may raise the cooling level of the battery cooling fan 30 for cooling the battery according to the calculated estimated driving time duration (S213).

In detail, when the calculated estimated driving time duration is shorter than the reference time duration, the controller 20 may not perform preliminary overcooling on the battery. When the calculated estimated driving time duration exceeds the reference time duration, the controller 20 may raise the cooling level of the battery cooling fan 30 in order to adjust a degree of the preliminary overcooling according to the estimated driving time duration. In this case, as the calculated estimated driving time duration is longer, the controller 20 may raise the cooling level of the battery cooling fan 30 for cooling the battery.

In a state in which the vehicle is not arrived at the destination yet (S217), if a vehicle door opens and closes (S215), the controller 20 may receive the signal indicating whether the passenger is in the back seat of the vehicle from the sensor installed at the door again (S207). Although the battery is cooled by controlling the cooling level of the battery cooling fan according to the calculated estimated driving time duration, when the passenger, who may primarily hear the noise of the battery cooling fan, gets in the back seat as the door opens and closes, the cooling level of the battery cooling fan may be minimized.

With the control method and the system for a battery cooling fan according to an exemplary embodiment of the present disclosure having the structure as described above, power unnecessarily consumed to overcool a battery may be reduced by using an estimated driving time duration as an input variable. Also, by lowering a rate of a high temperature of a high voltage battery in comparison to an existing cooling logic, battery durability life and battery output performance may be stably secured.

In addition, by installing a sensor at a door of a vehicle, life and reliability of the sensor may be enhanced in comparison to installing a sensor below a seat.

Although the present disclosure has been shown and described with respect to specific exemplary embodiments, it will be obvious to those skilled in the art that the present disclosure may be variously modified and altered without departing from the spirit and scope of the present disclosure as defined by the following claims.

What is claimed is:

1. A control method for a battery cooling fan, the control method comprising steps of:
calculating an estimated driving time duration; and
controlling cooling of a battery according to the calculated estimated driving time duration and a signal indicating whether a passenger is in a back seat of a vehicle from a sensor disposed at a vehicle door.

2. The control method of claim 1, wherein the step of calculating includes calculating a difference between a scheduled destination arrival time and a starting place driving start time input through a navigator.

3. The control method of claim 1, further comprising a step of:
comparing the calculated estimated driving time duration with a reference time duration.

4. The control method of claim 3, further comprising a step of:
when the calculated estimated driving time duration is longer than the reference time duration, receiving the signal indicating whether the passenger is in the back seat.

5. The control method of claim 3, wherein, in the step of controlling, when the calculated estimated driving time duration is shorter than the reference time duration, a cooling level of the battery cooling fan of the battery is minimized.

6. The control method of claim 4, wherein when the signal indicating that the passenger is in the back seat is received, the cooling level of the battery cooling fan is minimized.

7. The control method of claim 1, wherein the step of controlling includes raising the cooling level of the battery cooling fan for cooling the battery as the calculated estimated driving time duration is longer than the reference time duration.

8. The control method of claim 1, wherein the signal indicating whether the passenger is in the back seat is received again when the door opens and closes.

9. A control system for a battery cooling fan, the control system comprising:
a navigator configured to receive operation information;
a sensor configured to sense whether a passenger is in a back seat; and
a controller configured to calculate an estimated driving time duration on the basis of the operation information, and to control an operation of the battery cooling fan for cooling a battery on the basis of the calculated estimated driving time duration and a signal indicating whether the passenger is in the back seat from the sensor,
wherein the sensor is disposed at a vehicle door.
